(19) United States
(12) Patent Application Publication
(10) Pub. No.: US 2025/0157016 A1
(43) Pub. Date: May 15, 2025

(54) PRODUCT QUANTITY DETERMINATION APPARATUS, PRODUCT QUANTITY DETERMINATION METHOD, AND NON-TRANSITORY COMPUTER-READABLE MEDIUM

(71) Applicant: NEC Corporation, Minato-ku, Tokyo (JP)

(72) Inventors: Soma SHIRAISHI, Tokyo (JP); Takami Sato, Tokyo (JP); Tomokazu Kaneko, Tokyo (JP)

(73) Assignee: NEC Corporation, Minato-ku, Tokyo (JP)

(21) Appl. No.: 18/833,454

(22) PCT Filed: Mar. 30, 2022
(86) PCT No.: PCT/JP2022/015835

§ 371 Date: Jul. 26, 2024

(51) Int. Cl. G06T 7/00; G06Q 20/20

(52) U.S. Cl. CPC G06T 7/0002; G06Q 20/208; G06T 2207/30242

(57) ABSTRACT

A product quantity determination apparatus includes an acquisition unit, an image processing unit, and a computation unit. The acquisition unit acquires a plurality of images generated by a capture apparatus. A capture range of the capture apparatus includes, in a capture range, a first area where a product of a payment target is located, and a second area different from the first area. The image processing unit processes a plurality of images acquired by the acquisition unit, thereby determines a first number being the number of objects located in the first area, and determines a second number being the number of objects that have moved from the first area to the second area. The computation unit computes a third number being the number of the products, by use of the first number and the second number.

### TECHNICAL FIELD

The present invention relates to a product quantity determination apparatus, a product quantity determination method, and a storage medium.

### BACKGROUND ART

In recent years, it has been considered that, when a product is paid for, an image of the product is acquired and processed, and a result of the processing is utilized.

For example, Patent Document 1 discloses an object quantity estimation apparatus intended to estimate, with a little effort, the number of objects included in an image. The apparatus first generates a first feature map by performing convolution processing on a target image. Next, the apparatus processes the first feature map, and thereby estimates the number of target objects whose size is included in a first predetermined range. Next, the apparatus generates a second feature map by performing convolution processing on the first feature map. Next, the apparatus processes the second feature map, and thereby estimates the number of target objects whose size is included in a second predetermined range. The size included in the first predetermined range is smaller than the size included in the second predetermined range.

Moreover, Patent Document 2 discloses an article recognition apparatus intended to improve recognition accuracy of an article. The apparatus first acquires an image. A camera that generates the image captures an area including a mounting surface on which an object to be recognized is mounted. Next, the apparatus outputs an image for display to a display apparatus that displays an image on the mounting surface. Next, the apparatus generates, based on a first image captured by the camera described above, a background image to be displayed on the mounting surface. Then, the apparatus acquires a second image. The second image is generated by the camera described above in a state where the display apparatus described above displays the background image described above. Then, the apparatus determines, from the second image, an area of the article mounted on the mounting surface.

Note that, Patent Document 3 discloses an apparatus that performs the following processing. First, a sensor that senses that a scanned and registered product has been moved to a stock unit is provided. Then, the apparatus counts, for each customer, the number of times registration of a purchased product by a scanner has been performed, and also counts, for each customer, the number of times movement of a product has been sensed by a sensor. Then, the apparatus compares two numerical values, and, when the numerical values do not match, determines that an operational error or a fraud has been performed and issues a warning.

### RELATED DOCUMENT

### Patent Document

Patent Document 1: International Patent Publication No. WO2021/038840
Patent Document 2: Japanese Patent Application Publication No. 2020-190887
Patent Document 3: Japanese Patent Application Publication No. H07-182561

### SUMMARY

### Technical Problem

The present inventors have considered determining presence or absence of a possibility that a product is not registered precisely, by comparing the number of products registered with a product registration apparatus and the number of products included in an image capturing an area including the product registration apparatus. When performing the processing, it is necessary to accurately detect the number of products included in an image. However, with the techniques described in Patent Document 1 and a technique described in Patent Document 2 described above, there is a possibility that the number of products cannot be accurately detected.

In view of the problem described above, one example of an object of the present invention is to provide a product quantity determination apparatus, a product quantity determination method, and a storage medium that can accurately detect the number of products included in an image.

### Solution to Problem

According to one aspect of the present invention, there is provided a product quantity determination apparatus including:
an acquisition unit that acquires a plurality of images generated by an image capturing unit including, in a capture range, a first area where a product of a payment target is located, and a second area different from the first area;
an image processing unit that processes the plurality of images, thereby determines a first number being the number of objects located in the first area, and determines a second number being the number of objects that have moved from the first area to the second area; and
a computation unit that computes a third number being the number of the products, by use of the first number and the second number.

According to one aspect of the present invention, there is provided a product quantity determination method including,
by a computer:
   acquiring a plurality of images generated by an image capturing unit including, in a capture range, a first area where a product of a payment target is located, and a second area different from the first area;
   processing the plurality of images, thereby determining a first number being the number of objects located in the first area, and determining a second number being the number of objects that have moved from the first area to the second area; and
   computing a third number being the number of the products, by use of the first number and the second number.

According to one aspect of the present invention, there is provided a computer-readable storage medium storing a program that causes a computer to include:
an acquisition function of acquiring a plurality of images generated by an image capturing unit including, in a capture range, a first area where a product of a payment target is located, and a second area different from the first area;
an image processing function of processing the plurality of images, thereby determining a first number being the number of objects located in the first area, and determining a second number being the number of objects that have moved from the first area to the second area; and
a computation function of computing a third number being the number of the products, by use of the first number and the second number.

### Advantageous Effects of Invention

According to one aspect of the present invention, a product quantity determination apparatus, a product quantity determination method, and a storage medium that can accurately detect the number of products included in an image can be provided.

### BRIEF DESCRIPTION OF DRAWINGS

FIG. 1 It is a diagram illustrating an outline of a product quantity determination apparatus according to an example embodiment.

FIG. 2 It is a diagram for describing a usage environment of the product quantity determination apparatus.

FIG. 3 It is a diagram for describing one example of a capture range of a capture apparatus.

FIG. 4 It is a diagram illustrating one example of a functional configuration of the product quantity determination apparatus.

FIG. 5 It is a diagram illustrating a hardware configuration example of the product quantity determination apparatus.

FIG. 6 It is a flowchart illustrating one example of processing that the product quantity determination apparatus performs.

### EXAMPLE EMBODIMENT

Hereinafter, an example embodiment of the present invention is described by use of the drawings. Note that, a similar reference sign is assigned to a similar component in all the drawings, and description thereof will not be repeated as appropriate.

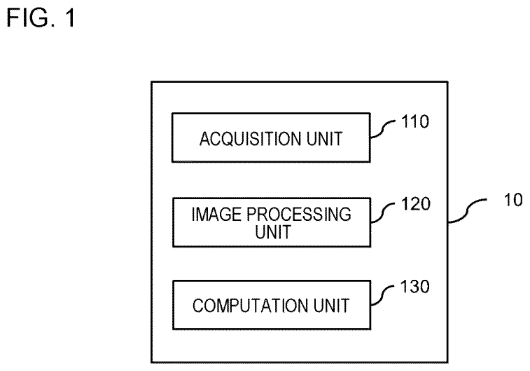

FIG. 1 is a diagram illustrating an outline of a product quantity determination apparatus 10 according to an example embodiment. The product quantity determination apparatus 10 includes an acquisition unit 110, an image processing unit 120, and a computation unit 130. The acquisition unit 110 acquires a plurality of images generated by the capture apparatus. The capture range of the capture apparatus includes, in a capture range, a first area where a product of a payment target is located, and a second area different from the first area. The image processing unit 120 processes the plurality of images acquired by the acquisition unit 110, thereby determines a first number being the number of objects located in the first area, and determines a second number being the number of objects that have moved from the first area to the second area. The computation unit 130 computes a third number being the number of the products, by use of the first number and the second number.

An object other than a product, for example, a communication terminal such as a smartphone or a wallet, may be located in the first area. In this case, the first number indicates a sum of the number of products and the number of other objects. In contrast, the product quantity determination apparatus 10 determines a second number being the number of objects that have moved from the first area to the second area. By appropriately setting the second area, a possibility that the second number indicates the number of the other objects described above becomes higher. Then, the computation unit 130 computes a third number being the number of the products, by use of the first number and the second number. Therefore, the product quantity determination apparatus 10 can accurately detect the number of products included in an image.

Hereinafter, a detailed example of the product quantity determination apparatus 10 is described.

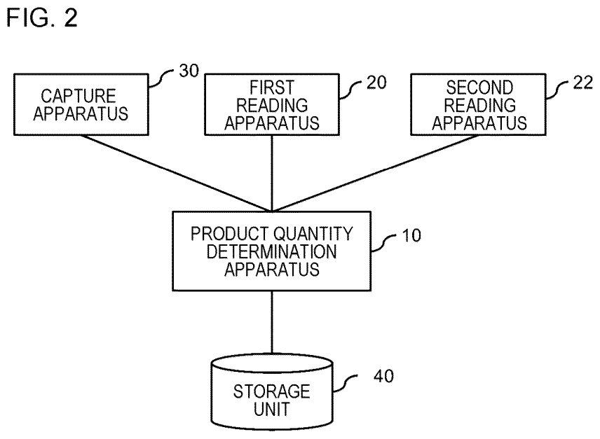

FIG. 2 is a diagram for describing a usage environment of the product quantity determination apparatus 10. In an example illustrated in the present figure, the product quantity determination apparatus 10 is used both as a product registration apparatus and a payment apparatus. However, as described later, the product quantity determination apparatus 10 may be an apparatus other than an apparatus that performs registration and payment of a product, for example, a cloud server.

The product quantity determination apparatus 10 is installed in a store or an office. When the product quantity determination apparatus 10 is installed in a store, a customer entering the store operates the product quantity determination apparatus 10 when purchasing a product. On the other hand, when the product quantity determination apparatus 10 is installed in an office, a product is displayed in a part of the office. Then, a person working in an office operates the product quantity determination apparatus 10 when purchasing the product.

The product quantity determination apparatus 10 is used together with a first reading apparatus 20, a second reading apparatus 22, a capture apparatus 30, and a storage unit 40. In the example illustrated in the present figure, the product quantity determination apparatus 10 is used when a customer purchases a product, and includes a product registration function and a payment function. That is to say, the product quantity determination apparatus 10 also functions as a product registration apparatus. Note that, the product quantity determination apparatus 10 does not have to include a payment function. In this case, the product quantity determination apparatus 10 transmits information indicating a registered product to the payment apparatus.

The first reading apparatus 20 acquires product identification information from a product that a customer is about to purchase, that is, a product to be a payment target. The first reading apparatus 20 may acquire product identification information by reading a code attached to a product, for example, a bar code or a two-dimensional code, or may acquire product identification information from a wireless communication tag attached to a product, for example, an RFID tag. The first reading apparatus 20 transmits the acquired product identification information to the product quantity determination apparatus 10. In this instance, the first reading apparatus 20 also transmits, to the product quantity determination apparatus 10, information indicating an acquisition timing of the product identification information, for example, acquisition date and time information. Hereinafter, this information is referred to as first timing information. The first timing information may be generated by the product quantity determination apparatus 10. In this case, the product quantity determination apparatus 10 generates first timing information such that the first timing information indicates a timing at which the product identification information is acquired from the first reading apparatus 20.

The second reading apparatus 22 reads information relating to a settlement method for a product from a medium having the information, and outputs the information to the product quantity determination apparatus 10. The settlement method for the product is an electronic settlement method, for example, one of electronic money in a prepaid form, a credit card, or code settlement. Then, the second reading apparatus 22 reads, from the medium storing the information, the information relating to the settlement method for the product, for example, identification information of electronic money, a credit card number, or information indicating a settlement method such as a code displayed on a terminal. The second reading apparatus 22 may acquire the pieces of information by image recognition, may acquire the pieces of information by near-field wireless communication, or may acquire the pieces of information from an IC chip provided in a medium.

Note that, at least one of the first reading apparatus 20 and the second reading apparatus 22 may be integrated with the product quantity determination apparatus 10.

The capture apparatus 30 repeatedly generates an image at least from a point at which the first reading apparatus 20 starts acquiring product identification information from the product to a point at which the second reading apparatus 22 reads information relating to a settlement method. The capture apparatus 30 may always generate an image. A frame rate of the capture apparatus 30 is, for example, equal to or more than 1 pfs and 30 pfs, but is not limited thereto.

Note that, the capture apparatus 30 may be attached to the product quantity determination apparatus 10, or may be attached above the product quantity determination apparatus 10, for example, on a ceiling.

A capture range of the capture apparatus 30 includes a first area where a product of a payment target is located, and a second area different from the first area. The first area may be two-dimensional or three-dimensional. Similarly, the second area may also be two-dimensional or three-dimensional. A specific example of the two areas is described later by use of another figure. Then, the capture apparatus 30 transmits the generated image to the product quantity determination apparatus 10. In this instance, the capture apparatus 30 also transmits, to the product quantity determination apparatus 10, information indicating a generation timing of the image, for example, generation date and time information. Hereinafter, the information is referred to as second timing information.

The storage unit 40 stores product identification information and a price for each of a plurality of products. The product quantity determination apparatus 10 uses information stored in the storage unit 40 when performing payment processing for a product. The storage unit 40 may be, for example, a server installed in a store where the product quantity determination apparatus 10 is located.

Note that, the product quantity determination apparatus 10 does not have to perform registration processing and payment processing for a target product. In this case, the product quantity determination apparatus 10 is an apparatus, for example, a cloud server or the like, other than a terminal that performs registration processing and payment processing, for example, a POS terminal. Then, the first reading apparatus 20 communicates with the terminal.

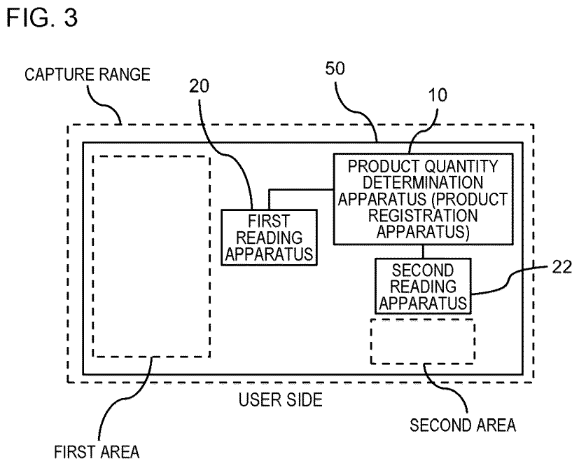

FIG. 3 is a diagram for describing one example of a capture range of the capture apparatus 30. In the example illustrated in the present figure, the product quantity determination apparatus 10 is used when a product is purchased, and is mounted on a stand 50. The stand 50 is sufficiently larger than the product quantity determination apparatus 10, and a part thereof is a first area. The first area is an area where a product that a customer is about to purchase, that is, a product to be a payment target is temporarily located, and is an empty space.

Attached equipment of the product quantity determination apparatus 10, for example, the first reading apparatus 20 and the second reading apparatus 22, are located on the stand 50. The first reading apparatus 20 reads product identification information from the product. The second reading apparatus 22 reads, from a medium such as a mobile terminal or a card, information relating to a settlement means used at payment. The second area includes an area where the medium is located during the reading. Moreover, the second area includes a range in which the second reading apparatus 22 is capable of reading information from the medium.

When purchasing a product, a customer often places a medium or a wallet together with a product in the first area. In this case, at payment, the customer takes out the medium or the wallet from the first area, and moves the medium or the wallet to the second area. Thus, there is a high possibility that an object that has moved from the first area to the second area is not a product. The product quantity determination apparatus 10 processes a plurality of images generated by the capture apparatus 30, and thereby computes the number of objects that have moved in this way, that is, the second number.

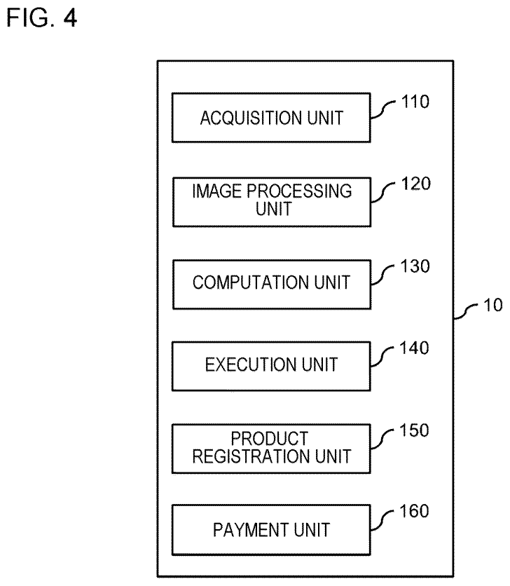

FIG. 4 is a diagram illustrating one example of a functional configuration of the product quantity determination apparatus 10. As described by use of FIG. 1, the product quantity determination apparatus 10 includes the acquisition unit 110, the image processing unit 120, and the computation unit 130. In the example illustrated in the present figure, the product quantity determination apparatus 10 further includes an execution unit 140, a product registration unit 150, and a payment unit 160.

As described above, the capture apparatus 30 constantly generates an image at least while the first reading apparatus 20 is acquiring product identification information. Then, the acquisition unit 110 acquires the image generated by the capture apparatus 30. In this instance, the acquisition unit 110 also acquires the second timing information.

The product registration unit 150 acquires product identification information from the first reading apparatus 20. In this instance, the product registration unit 150 also acquires first timing information. The product registration unit 150 generates registration information indicating a product to be a payment target. The registration information includes a list of product identification information of a product to be a payment target, information indicating a total number of products to be payment targets, and information indicating the number of the products for each product. Hereinafter, the total number of products based on the registration information is referred to as a fourth number.

The image processing unit 120 performs detection processing of an object existing in the first area, on each of a plurality of images generated by the capture apparatus 30. The image processing unit 120 may perform detection processing of an object by use of a model generated by machine learning, or may perform detection processing of an object by feature value matching. Information necessary when the image processing unit 120 performs detection processing of an object is stored in, for example, the storage unit 40.

Then, the image processing unit 120 computes, by use of results of the pieces of detection processing, a total number of objects existing in the first area, that is, the first number. In this instance, the image processing unit 120 may track the object between a plurality of images, and determine the first number by use of the tracking results.

Moreover, the image processing unit 120 determines the number of objects that have moved from the first area to the second area, that is, the second number, by tracking the objects between a plurality of images. In this instance, even when the same object moves from the first area to the second area a plurality of times, the image processing unit 120 does not include the second and subsequent movements in the second number.

Note that, the image processing unit 120 may continue performing the detection processing by use of a newly generated image until payment processing is completed. In this case, the image processing unit 120 increases the second number every time an object that has moved from the first area to the second area is detected. In this instance, the image processing unit 120 does not increase the second number in relation to the second and subsequent movements from the first area to the second area even when a movement is made in an order of the first area, the second area, the first area, and the second area.

Note that, the image processing unit 120 may determine a target image being an image to be a processing target for computing the second number, by use of, for example, the first timing information and the second timing information. For example, the image processing unit 120 may determine, as the target image, an image generated from a point a first predetermined time before a date and time indicated by first timing information of product identification information acquired first, to a point a second predetermined time after a date and time indicated by first timing information of product identification information acquired last. The first predetermined time is, for example, equal to or more than 1 second and equal to or less than 30 seconds, but may be outside the ranges. Moreover, the second predetermined time is, for example, equal to or more than 10 seconds and equal to or less than 30 seconds.

Herein, a product indicated by the “product identification information acquired first” is, for example, a product for which a certain customer has caused the first reading apparatus 20 to read product identification information first among products to be payment targets of the customer. In other words, the “product identification information acquired first” corresponds to product identification information that a certain customer has caused the first reading apparatus 20 to read first. For example, when the customer performs, on the product quantity determination apparatus 10, input to start registration processing of a product, product identification information input immediately thereafter corresponds to the “product identification information acquired first”.

On the other hand, a product indicated by the “product identification information acquired last” is, for example, a product for which a certain customer has caused the first reading apparatus 20 to read product identification information last among products to be payment targets of the customer. In other words, the “product identification information acquired last” corresponds to product identification information that a certain customer has caused the first reading apparatus 20 to read last. For example, when the customer performs, on the product quantity determination apparatus 10, input to proceed to payment processing, product identification information input immediately therebefore corresponds to the “product identification information acquired last”.

Note that, the specific examples of “product identification information acquired first” and “product identification information acquired last” are not limited to the examples described above. For example, when respective dates and times indicated by certain first timing information and next first timing information are apart from each other by equal to or more than a predetermined time, the “certain first timing information” may be “first timing information of product identification information acquired last” of a certain customer. In this case, the “next first timing information” is product identification information input first among products that a next customer plans to purchase.

Alternatively, the image processing unit 120 may determine a third timing being a timing at which the product quantity determination apparatus 10 acquires information read by the second reading apparatus 22, and select the target image by use of the third timing. For example, the image processing unit 120 selects, as the target image, an image generated from a point a first predetermined time before a date and time indicated by the first timing information of the product identification information acquired first to this timing.

As described by use of FIG. 1, the computation unit 130 computes, by use of the first number and the second number, a third number being the number of products to be payment targets. For example, the computation unit 130 determines, as the third number, a value acquired by subtracting the second number from the first number.

The execution unit 140 executes predetermined processing when a difference between a fourth number being a total number of products registered by the product registration unit 150, and the third number is equal to or more than a criterion value. The criterion value is, for example, 1, but may be equal to or more than 2. A fact that the difference is equal to or more than the criterion value indicates that there is a possibility that a total number of products registered in the product registration unit 150 is different from a total number of products that a customer or a person working in an office is about to purchase. Then, one example of predetermined processing is output processing of warning information. The execution unit 140 may output the warning information to a display or a speaker included in the product quantity determination apparatus 10, or may output warning information to a terminal operated by a manager who manages product sales, for example, a terminal operated by a clerk of a store.

When the execution unit 140 does not perform predetermined processing, that is, when there is a high possibility that a total number of products registered in the product registration unit 150 matches a total number of products that a customer or a person working in an office is about to purchase, the payment unit 160 performs payment processing by use of registration information generated by the product registration unit 150, that is, a list of product identification information of a product to be a payment target. In this instance, the payment unit 160 uses information stored in the storage unit 40.

Note that, when the product quantity determination apparatus 10 is used as an apparatus such as a cloud server other than an apparatus that performs registration and payment of a product, the product quantity determination apparatus 10 does not include the product registration unit 150 and the payment unit 160. In this case, an apparatus including the product registration unit 150 and the payment unit 160, for example, a POS terminal is located, for example, at a position of the product quantity determination apparatus 10 in FIG. 3, in addition to the product quantity determination apparatus 10. Hereinafter, the apparatus is referred to as a registration and payment apparatus. Then, the product quantity determination apparatus 10 acquires information indicating the fourth number from the registration and payment apparatus. The execution unit 140 of the product quantity determination apparatus 10 transmits, to the registration and payment apparatus, information indicating whether a difference between the third number and the fourth number is equal to or more than a criterion value. When the difference between the third number and the fourth number is equal to or more than the criterion value, the registration and payment apparatus causes predetermined information to be displayed on a display of the apparatus, or output from a speaker of the apparatus.

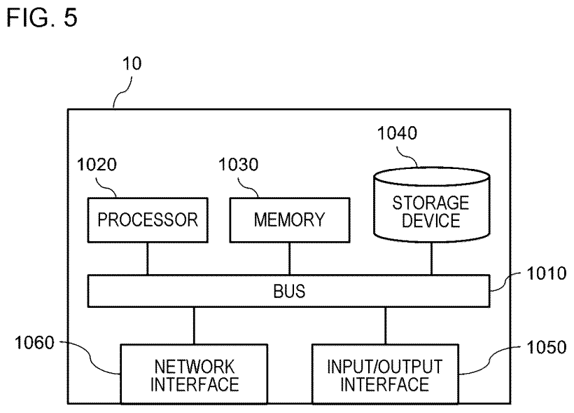

FIG. 5 is a diagram illustrating a hardware configuration example of the product quantity determination apparatus 10. The product quantity determination apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit and receive data to and from each other. However, a method of connecting the processor 1020 and the like to each other is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a removable medium such as a memory card, a read only memory (ROM), or the like, and has a storage medium. A storage medium of the storage device 1040 stores a program module that achieves each function (e.g. the acquisition unit 110, the image processing unit 120, the computation unit 130, the execution unit 140, the product registration unit 150, and the payment unit 160) of the product quantity determination apparatus 10. The processor 1020 reads each of the program modules onto the memory 1030, executes the read program module, and thereby achieves each function being associated with the program module. Moreover, the storage device 1040 may also function as the storage unit 40.

The input/output interface 1050 is an interface for connecting the product quantity determination apparatus 10 to various kinds of input/output equipment. For example, the product quantity determination apparatus 10 communicates with at least one of the first reading apparatus 20, the second reading apparatus 22, the capture apparatus 30, and the storage unit 40 via the input/output interface 1050.

The network interface 1060 is an interface for connecting the product quantity determination apparatus 10 to a network. The network is, for example, a local area network (LAN) or a wide area network (WAN). A method of connecting the network interface 1060 to the network may be wireless connection, or may be wired connection. The product quantity determination apparatus 10 may communicate with at least one of the capture apparatus 30 and the storage unit 40 via the network interface 1060.

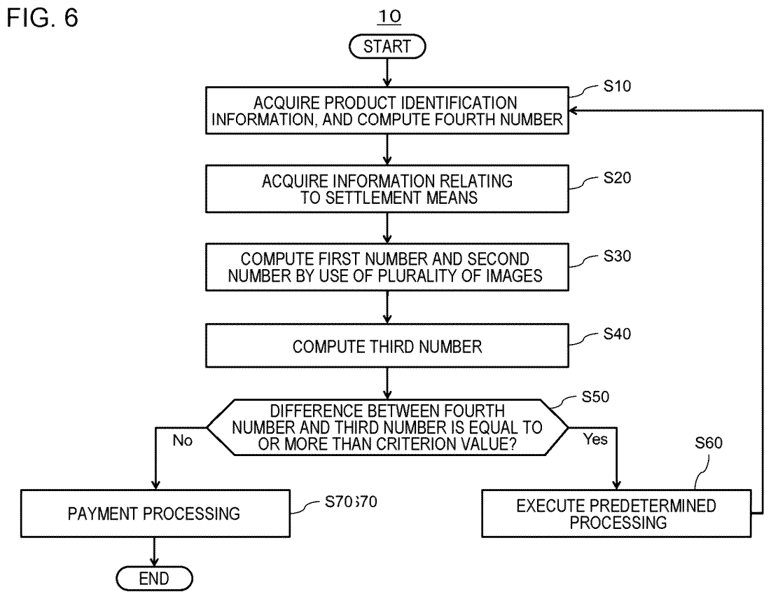

FIG. 6 is a flowchart illustrating one example of processing that the product quantity determination apparatus 10 performs.

When purchasing a product, a customer or a person working in an office causes the first reading apparatus 20 to read product identification information of the product. The product registration unit 150 of the product quantity determination apparatus 10 acquires the product identification information. When there are a plurality of products to be payment targets, the product registration unit 150 acquires product identification information for each of the plurality of products. Then, the product registration unit 150 computes a fourth number (step S10).

Then, after causing the first reading apparatus 20 to read product identification information from all products, the customer causes the second reading apparatus 22 to read information relating to a settlement means from a medium (step S20).

Moreover, the acquisition unit 110 acquires a plurality of images generated by the capture apparatus 30. At least some of the plurality of images are generated while the processing described above is performed. Then, the image processing unit 120 computes a first number and a second number by processing the plurality of images (step S30). A specific example of processing performed herein is as described by use of FIG. 4.

Then, the computation unit 130 computes a third number by use of the first number and the second number computed by the image processing unit 120 (step S40). A specific example of processing performed herein is as described by use of FIG. 4.

Then, when a difference between the fourth number and the third number is equal to or more than a criterion value (step S50: Yes), the execution unit 140 executes predetermined processing (step S60). One example of the predetermined processing is warning processing. Thereafter, the product quantity determination apparatus 10 returns the process to step S10.

On the other hand, when a difference between the fourth number and the third number is less than a criterion value (step S50: No), the payment unit 160 performs payment processing by use of information relating to the settlement means read by the second reading apparatus 22 (step S70).

As described above, according to the present example embodiment, the image processing unit 120 of the product quantity determination apparatus 10 processes a plurality of images generated by the capture apparatus 30, thereby determines a first number being the number of objects located in the first area, and determines a second number being the number of objects that have moved from the first area to the second area. Although products to be payment targets are located in the first area, an object other than the products, for example, a communication terminal such as a smartphone or a wallet, may be located in the first area. In this case, the first number indicates a sum of the number of products and the number of other objects. In this regard, the computation unit 130 computes a third number being the number of products, by use of the first number and the second number. Therefore, the product quantity determination apparatus 10 can accurately detect the number of products included in an image.

The example embodiments of the present invention have been described above with reference to the drawings, but are exemplifications of the present invention, and various configurations other than those described above can also be adopted.

Moreover, although a plurality of steps (pieces of processing) are described in order in the flowcharts used in the above description, an execution order of steps executed in each example embodiment is not limited to the described order. In each example embodiment, an order of illustrated steps can be changed to an extent that causes no problem in terms of content. Moreover, at least one step may be performed by another actor, for example, another apparatus or person. Moreover, each of the example embodiments described above can be combined to an extent that content does not contradict.

Some or all of the above-described example embodiments can also be described as, but are not limited to, the following supplementary notes.

1. A product quantity determination apparatus including:
an acquisition unit that acquires a plurality of images generated by an image capturing unit including, in a capture range, a first area where a product of a payment target is located, and a second area different from the first area;
an image processing unit that processes the plurality of images, thereby determines a first number being the number of objects located in the first area, and determines a second number being the number of objects that have moved from the first area to the second area; and
a computation unit that computes a third number being the number of the products, by use of the first number and the second number.

2. The product quantity determination apparatus according to supplementary note 1, in which
the second area includes an area in which a medium having information relating to a settlement method for the product is placed when the information is input to a payment apparatus.

3. The product quantity determination apparatus according to supplementary note 2, in which
the payment apparatus acquires the information from a reading apparatus that reads the information from the medium, and
the second area includes a range in which the reading apparatus is capable of reading the information from the medium.

4. The product quantity determination apparatus according to supplementary note 2 or 3, in which
the image processing unit
   determines a timing at which the information is input to the payment apparatus,
   selects a target image from among the plurality of images by use of the timing, and
   determines the second number by use of the target image.

5. The product quantity determination apparatus according to any one of supplementary notes 1 to 4, in which
the image processing unit does not include second and subsequent movements in the second number when the same object moves a plurality of times from the first area to the second area.

6. The product quantity determination apparatus according to any one of supplementary notes 1 to 4, further including
an execution unit that executes predetermined processing when a difference between a fourth number being the number of products registered by a product registration unit, and the third number is equal to or more than a criterion value.

7. A product quantity determination method including,
by a computer:
   acquiring a plurality of images generated by an image capturing unit including, in a capture range, a first area where a product of a payment target is located, and a second area different from the first area;
   processing the plurality of images, thereby determining a first number being the number of objects located in the first area, and determining a second number being the number of objects that have moved from the first area to the second area; and
   computing a third number being the number of the products, by use of the first number and the second number.

8. The product quantity determination method according to supplementary note 7, in which
the second area includes an area in which a medium having information relating to a settlement method for the product is placed when the information is input to a payment apparatus.

9. The product quantity determination method according to supplementary note 8, in which
the payment apparatus acquires the information from a reading apparatus that reads the information from the medium, and
the second area includes a range in which the reading apparatus is capable of reading the information from the medium.

10. The product quantity determination method according to supplementary note 8 or 9, further including,
by the computer:
   determining a timing at which the information is input to the payment apparatus,
   selecting a target image from among the plurality of images by use of the timing, and determining the second number by use of the target image.

11. The product quantity determination method according to any one of supplementary notes 7 to 10, further including,
by the computer, not including second and subsequent movements in the second number when the same object moves a plurality of times from the first area to the second area.

12. The product quantity determination method according to any one of supplementary notes 7 to 10, further including
by the computer, executing predetermined processing when a difference between a fourth number being the number of products registered by a product registration unit, and the third number is equal to or more than a criterion value.

13. A computer-readable storage medium storing a program that causes a computer to include:
an acquisition function of acquiring a plurality of images generated by an image capturing unit including, in a capture range, a first area where a product of a payment target is located, and a second area different from the first area;
an image processing function of processing the plurality of images, thereby determining a first number being the number of objects located in the first area, and determining a second number being the number of objects that have moved from the first area to the second area; and
a computation function of computing a third number being the number of the products, by use of the first number and the second number.

14. The storage medium according to supplementary note 13, in which
the second area includes an area in which a medium having information relating to a settlement method for the product is placed when the information is input to a payment apparatus.

15. The storage medium according to supplementary note 14, in which
the payment apparatus acquires the information from a reading apparatus that reads the information from the medium, and
the second area includes a range in which the reading apparatus is capable of reading the information from the medium.

16. The storage medium according to supplementary note 14 or 15, in which
the image processing function
   determines a timing at which the information is input to the payment apparatus,
   selects a target image from among the plurality of images by use of the timing, and
   determines the second number by use of the target image.

17. The storage medium according to any one of supplementary notes 13 to 16, in which
the image processing function does not include second and subsequent movements in the second number when the same object moves a plurality of times from the first area to the second area.

18. The storage medium according to any one of supplementary notes 13 to 16, in which
the program causes the computer to include an execution function of executing predetermined processing when a difference between a fourth number being the number of products registered by a product registration unit, and the third number is equal to or more than a criterion value.

19. The program according to any one of supplementary notes 13 to 18.

### REFERENCE SIGNS LIST

10 Product quantity determination apparatus
20 First reading apparatus
22 Second reading apparatus
30 Capture apparatus
40 Storage unit
110 Acquisition unit
120 Image processing unit
130 Computation unit
140 Execution unit
150 Product registration unit
160 Payment unit

What is claimed is:

1. A product quantity determination apparatus comprising:
at least one memory configured to store instructions; and
at least one processor configured to execute instructions to perform operations;
a plurality of images generated by a camera including, in a capture range, a first area where a product of a payment target is located, and a second area different from the first area;
processing the plurality of images, thereby determines a first number being the number of objects located in the first area, and determining a second number being the number of objects that have moved from the first area to the second area; and
computing a third number being the number of the products, by use of the first number and the second number.

2. The product quantity determination apparatus according to claim 1, wherein
the second area includes an area in which a medium having information relating to a settlement method for the product is placed when the information is input to a payment apparatus.

3. The product quantity determination apparatus according to claim 2, wherein
the payment apparatus acquires the information from a reading apparatus that reads the information from the medium, and
the second area includes a range in which the reading apparatus is capable of reading the information from the medium.

4. The product quantity determination apparatus according to claim 2, wherein
the operations further comprise
determining a timing at which the information is input to the payment apparatus,
selecting a target image from among the plurality of images by use of the timing, and
determining the second number by use of the target image.

5. The product quantity determination apparatus according to claim 1, wherein the operations further comprise
not including second and subsequent movements in the second number when the same object moves a plurality of times from the first area to the second area.

6. The product quantity determination apparatus according to claim 1, wherein the operations further comprise
executing predetermined processing when a difference between a fourth number being the number of registered products, and the third number is equal to or more than a criterion value.

7. A product quantity determination method comprising,
by a computer:
acquiring a plurality of images generated by a camera including, in a capture range, a first area where a product of a payment target is located, and a second area different from the first area;
processing the plurality of images, thereby determining a first number being the number of objects located in the first area, and determining a second number being the number of objects that have moved from the first area to the second area; and
computing a third number being the number of the products, by use of the first number and the second number.

8. A non-transitory computer-readable medium storing a program that causes a computer to perform operations comprising:
acquiring a plurality of images generated by a camera including, in a capture range, a first area where a product of a payment target is located, and a second area different from the first area;
processing the plurality of images, thereby determining a first number being the number of objects located in the first area, and determining a second number being the number of objects that have moved from the first area to the second area; and
computing a third number being the number of the products, by use of the first number and the second number.
